(19) United States
(12) Patent Application Publication
(10) Pub. No.: US 2007/0058395 A1
(43) Pub. Date: Mar. 15, 2007

(54) Light guide plate with reflective layer and backlight module and liquid crystal display with same

(75) Inventor: Chien-Chung Fang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/519,035

(22) Filed: Sep. 11, 2006

(30) Foreign Application Priority Data
Sep. 9, 2005 (TW) 94131001

(51) Int. Cl. F21V 7/04

(52) U.S. Cl. 362/615

(57) ABSTRACT

An exemplary light guide plate (34) includes a main body, and a reflective layer (348). The main body includes a light incident surface (342), and a bottom surface (346) adjacent to the light incident surface. The reflective layer is formed on the bottom surface of the main body such that the main body and the reflective layers are an integrated whole. A liquid crystal display (1) and a backlight module (2) including the light guide plate are also provided.

### FIELD OF THE INVENTION

The present invention relates to light guide plates for backlight modules such as those used in liquid crystal displays (LCDs); and more particularly to a light guide plate with a reflective layer integrally formed thereon, and a backlight module and an LCD having the light guide plate.

### GENERAL BACKGROUND

Liquid crystal displays are commonly used as display devices for compact electronic apparatuses, because they not only provide good quality images but are also very thin. Because liquid crystal molecules in a liquid crystal display do not emit any light themselves, the liquid crystal molecules have to be lit by a light source so as to clearly and sharply display text and images. Therefore, liquid crystal displays usually require a backlight module.

Referring to FIG. 3, a typical backlight module 4 includes a brightness enhancement film (BEF) 40, a diffusing film 42, a light guide plate (LGP) 44, and a reflective film 46, arranged in that order from top to bottom. The backlight module 4 further includes a light source 48 disposed adjacent to a light incident surface 442 of the light guide plate 44.

The light guide plate 44 includes a top light emitting surface 444 perpendicularly adjoining the light incident surface 442, and a bottom surface 446 opposite to the light emitting surface 444. A plurality of diffusing dots 448 are formed on the light emitting surface 444 and the bottom surface 446. The reflective film 46 is disposed adjacent to the bottom surface 446 of the light guide plate 44. The diffusing film 42 is disposed adjacent to the light emitting surface 444 of the light guide plate 44. In assembly of the backlight module 4, a step of aligning and attaching the reflective film 46 to the bottom surface 446 of the light guide plate 44 is needed, which adds to the cost of manufacturing the backlight module 4. Further, the reflective film 46 is liable to loosen or even fall off from the light guide plate 44 when the backlight module 4 is subjected to vibration or shock during operation or transportation. If the reflective film 46 becomes displaced, the optical performance of the backlight module 4 may be impaired.

What is needed, therefore, is a backlight module that can overcome the above-described deficiencies. What is also need is a liquid crystal display employing such a backlight module.

### SUMMARY

In a preferred embodiment, a light guide plate includes a main body, and a reflective layer. The main body includes a light incident surface, and a bottom surface adjacent to the light incident surface. The reflective layer is formed on the bottom surface of the main body such that the main body and the reflective layer are an integrated whole.

Other aspects, advantages and novel features will become more apparent from the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles of at least one embodiment of the present invention. In the drawings, like reference numerals designate corresponding parts throughout various views, and all the views are schematic.

FIG. 1 is an exploded, side view of an exemplary embodiment of a liquid crystal display of the present invention, the liquid crystal display including a backlight module.

FIG. 2 is an enlarged, side cross-sectional view of the backlight module of the liquid crystal display of FIG. 1.

FIG. 3 is an exploded, side view of a conventional backlight module, showing essential optical paths thereof.

### DETAILED DESCRIPTION OF PREFERRED EMBODIMENTS

Reference will now be made to the drawings to describe the preferred embodiments in detail.

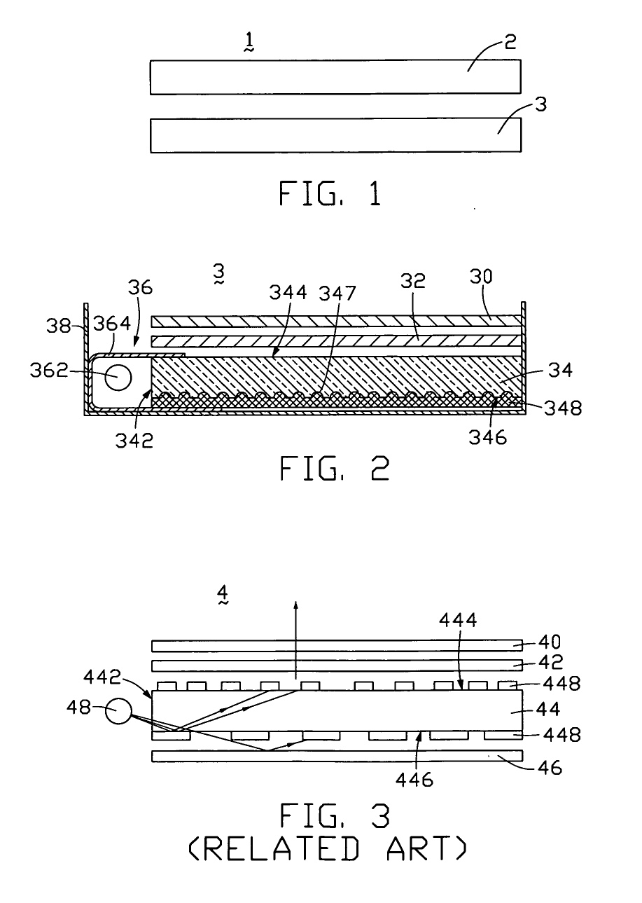

Referring to FIG. 1, a liquid crystal display 1 of an exemplary embodiment of the present invention is shown. The liquid crystal display 1 includes a liquid crystal panel 2, and a backlight module 3 disposed adjacent to the liquid crystal panel 2.

Referring also to FIG. 2, the backlight module 3 includes a brightness enhancement film (BEF) 30, a diffusing film 32, a light guide plate 34, a light source 36, and a frame 38. The BEF 30, the diffusing film 32, and the light guide plate 34 are arranged in that order from top to bottom. The light source 36 is disposed adjacent to a light incident surface 342 of the light guide plate 34. The BEF 30, the diffusing film 32, the light guide plate 34, and the light source 36 are received in the frame 38. The frame 38 is preferably made from plastic or any other suitable polymer.

The light guide plate 34 includes the light incident surface 342, a top surface 344 adjacent to the light incident surface 342, and a bottom surface 346 opposite to the top surface 344. The diffusing film 32 is disposed adjacent to the top surface 344 of the light guide plate 34.

A plurality of diffusing dots 347 are formed at the bottom surface 346 of the light guide plate 34. The diffusing dots 347 are discontinuously arranged. A pitch between each two adjacent diffusing dots 347 is constant. In an alternative embodiment, the pitch between each two adjacent diffusing dots 347 may progressively decrease with increasing distance away from the light incident surface 342. In the illustrated embodiment, each diffusing dot 347 is in the form of an indentation in the bottom surface 346. In particular, each diffusing dot 347 defines an arc-shaped cross-section. For example, each diffusing dot 347 may be generally hemispherical, sub-hemispherical, dome-shaped, semicylindrical, or sub-semicylindrical. The diffusing dots 347 can be formed by an injection molding method, a press molding method, or a transfer molding method. In an alternative embodiment, each diffusing dot 347 can be in the form of a protrusion on the bottom surface 346. In such case, a material from which the diffusing dots 347 are made can be the same as that of the light guide plate 34, or can be different from that of the light guide plate 34.

A reflective layer 348 is formed on the bottom surface 346 including the diffusing dots 347 of the light guide plate 34. That is, the reflective layer 348 directly abuts the diffusing dots 347, and extends over the whole bottom surface 346. The reflective layer 348 is made from a material with a high reflection index, for example, ink doped with silver ions. The reflective layer 348 can be formed by a spraying method, a printing method, or a deposition method.

The light guide plate 34 can for example be made from polycarbonate (PC) or polymethyl methacrylate (PMMA). A method for manufacturing the light guide plate 34 may include the following steps: first, providing a light guide plate preform; second, forming the plurality of diffusing dots 347 on the bottom surface 346 of the light guide plate preform; third, coating the reflective layer 348 on the bottom surface 346 having the diffusing dots 347. In an alternative embodiment, the reflective layer 348 can be printed on the bottom surface 346.

The light source 36 includes an illuminator 362, and a reflector 364 cooperating with the light incident surface 342 to generally surround the illuminator 362. A height of the reflector 364 is slightly larger than a thickness of the light guide plate 34, and end portions (not labeled) of the top surface 344 and the bottom surface 346 are covered by respective portions (not labeled) of the reflector 36. The illuminator 362 may be a cold cathode fluorescent lamp (CCFL), or one or more light emitting diodes (LEDs).

In operation, light beams emitted from the illuminator 362 transmit through the light incident surface 342 into the light guide plate 34, and are then converted by the light guide plate 34 to provide a surface light source at the top surface 344. Some of the light beams reach the top surface 344 without propagating to the bottom surface 346. These light beams emit out of the light guide plate 34 through the top surface 344, propagate to the diffusing film 32 where they undergo diffusion, propagate to the BEF 30 where they undergo refraction, and finally reach the liquid crystal panel 2. Other of the light beams reach the bottom surface 346, are diffused by the diffusing dots 347 thereon, and further propagate to the reflective layer 348. These light beams are reflected by the reflective layer 348 toward the top surface 344, and finally reach the liquid crystal panel 2 after being diffused by the diffusing film 32 and after being refracted by the BEF 30. The diffusing dots 347 diffuse light beams incident thereat, to increase the uniformity of light emission provided by the backlight module 3 for the liquid crystal panel 2.

Because the reflective layer 348 is formed with the light guide plate 34 such that the light guide plate 34 and the reflective layer 348 are an integrated whole, there is no need for a manufacturing step of aligning and attaching a separate reflective film to the bottom surface 346. Thereby, the cost of manufacturing the backlight module 3 can be reduced. Moreover, the integral configuration of the light guide plate 34 with the adjoining reflective layer 348 can help prevent the reflective layer 348 from loosening or falling off from the bottom surface 346 of the light guide plate 34 when the backlight module 3 is subjected to vibration or shock during operation or transportation. Furthermore, the complementary shapes of the diffusing dots 347 and the adjoining reflective layer 348 substantially interlock, thereby providing large contact areas and good mechanical stability as between the light guide plate 34 and the reflective layer 348. That is, the backlight module 3 has high stability and reliability.

Further or alternative embodiments may include the following. In one example, a plurality of diffusing dots 347 can be formed at the top surface 344 of the light guide plate 34 for further improving the uniformity of light emission provided by the backlight module 3 and the associated liquid crystal display 1. In another example, surfaces of the light guide plate 34 (except the light incident surface 342) between the top surface 344 and the bottom surface 346 can be coated with reflective material for improving a light utilization ratio of the backlight module 3. In a further example, the bottom surface 346 of the light guide plate 34 can be flat. In a still further example, the light guide plate 34 may include two light incident surfaces 342 that are opposite to each other or adjacent to each other. In such case, the backlight module 3 may have two or more light sources 48 respectively disposed adjacent to the light incident surfaces 342.

It is believed that the present embodiments and their advantages will be understood from the foregoing description, and it will be apparent that various changes may be made thereto without departing from the spirit or scope of the invention or sacrificing all of its material advantages, the examples hereinbefore described merely being preferred or exemplary embodiments of the invention.

What is claimed is:

1. A light guide plate comprising:
a main body comprising:
a light incident surface; and
a bottom surface adjacent to the light incident surface; and
a reflective layer formed on the bottom surface of the main body such that the main body and the reflective layer are an integrated whole.

2. The light guide plate in claim 1, further comprising a plurality of diffusing dots formed at the bottom surface.

3. The light guide plate in claim 2, wherein the diffusing dots are adjacent to the reflective layer.

4. The light guide plate in claim 3, wherein the reflective layer directly abuts the diffusing dots.

5. The light guide plate in claim 2, wherein the diffusing dots are discontinuously arranged.

6. The light guide plate in claim 5, wherein a pitch between each two adjacent diffusing dots is constant.

7. The light guide plate in claim 2, wherein each diffusing dot defines an arc-shaped cross-section.

8. The light guide plate in claim 7, wherein each diffusing dot is hemispherical, sub-hemispherical, dome-shaped, semicylindrical, or sub-semicylindrical.

9. The light guide plate in claim 2, wherein the reflective layer extends over the whole bottom surface of the main body including the diffusing dots.

10. The light guide plate in claim 1, wherein the reflective layer is made from material with a high reflection index.

11. The light guide plate in claim 10, wherein the reflective layer is made from inks doped with silver ions.

12. A backlight module comprising:
a light guide plate comprising:
a main body comprising:
a light incident surface; and
a bottom surface adjacent to the light incident surface; and
a reflective layer formed on the bottom surface of the main body such that the main body and the reflective layer are an integrated whole; and
a light source disposed adjacent to the light incident surface.

13. The backlight module in claim 12, wherein the light guide plate further comprises a plurality of diffusing dots formed at the bottom surface

14. The backlight module in claim 13, wherein the diffusing dots are adjacent to the reflective layer.

15. The backlight module in claim 14, wherein the reflective layer directly abuts the diffusing dots.

16. The backlight module in claim 13, wherein reflective layer extends over the whole bottom surface of the light guide plate including the diffusing dots.

17. The backlight module in claim 12, wherein the reflective layer is made from material with a high reflection index.

18. The backlight module in claim 17, wherein the reflective layer is made from inks doped with silver ions.

19. A liquid crystal display comprising:
a liquid crystal panel; and
a backlight module adjacent to the liquid crystal panel, the backlight module comprising:
a light guide plate comprising:
a main body comprising:
a light incident surface; and
a bottom surface adjacent to the light incident surface; and
a reflective layer formed on the bottom surface of the main body such that the main body and the reflective layer are an integrated whole; and
a light source disposed adjacent to the light incident surface of the light guide plate.
